(19) United States
(12) Patent Application Publication
(10) Pub. No.: US 2025/0191437 A1
(43) Pub. Date: Jun. 12, 2025

(54) SYSTEM AND METHOD FOR MANAGING CASINO GAMES AND SPORTS WAGERS PRESENTED ON A DISPLAY

(71) Applicants: Robert Hanson, II, Mobile, AL (US); Robert Hanson, III, Mobile, AL (US)

(72) Inventors: Robert Hanson, II, Mobile, AL (US); Robert Hanson, III, Mobile, AL (US)

(21) Appl. No.: 18/974,732

(22) Filed: Dec. 9, 2024

Related U.S. Application Data
(60) Provisional application No. 63/608,169, filed on Dec. 8, 2023.

(51) Int. Cl. G07F 17/32; G06F 3/16; G06N 20/00

(52) U.S. Cl. CPC G07F 17/3227; G06F 3/167; G06N 20/00; G07F 17/3211; G07F 17/3237; G07F 17/3281

(57) ABSTRACT

A system and method for managing wagers and casino games on a display is provided. Generally, the system comprises a computing device and display in fluid communication with one another such that a user may choose sporting events, casino games, and/or other applications via a user interface of the computing device that will be presented in a display user interface of said display. Users may use a display and computing device connected to the display to watch sporting events, make sports wagers, play casino games, and view applications.

### CROSS REFERENCES

This application claims priority to U.S. Provisional Application Ser. No. 63/608,169, filed on Dec. 8, 2023, in which application is incorporated herein in its entirety by reference.

### FIELD OF THE DISCLOSURE

The subject matter of the present disclosure refers generally to a system and method for managing casino games and sports wagers on a split screen.

### BACKGROUND

AI, particularly machine learning, has permeated numerous sectors, ranging from healthcare to finance, and sports betting is no exception. AI-driven betting recommendations leverage vast datasets, predictive analytics, and algorithms to generate wager suggestions that are more informed, data-driven, and potentially profitable. These recommendations encompass various sports and events, from football and basketball to horse racing and beyond. AI systems ingest and analyze immense volumes of data, including historical match statistics, player performance, weather conditions, and injury reports. This data is transformed into valuable insights, enabling AI to identify trends and patterns that might elude human analysis. Consequently, AI can provide more accurate predictions of upcoming events.

Additionally, AI recommendations may be personalized to individual users. By considering a bettor's history, preferences, and risk tolerance, AI can generate tailored wager suggestions that align with the bettor's objectives. This personalization enhances the user experience and can lead to more effective betting strategies. However, most institutions that allow gambling have strict age requirements, and using AI to recommend wagers could entice minors to gamble if protective measures are not put in place. Further, though AI can be used to recommend personalized wagers for users, there are often limited displays for viewing live feeds of sporting events, meaning users may be dissuaded from placing certain wagers if the sporting event cannot be viewed.

Accordingly, there is a need in the art for an AI system that recommends wagers for users and can split displays in multiple ways to allow a user to view multiple sporting events based on wagers that have been placed.

### SUMMARY

A system and method for presenting content related to gambling on displays is provided. In one aspect, the present invention is a system and method for organizing a gambling experience on a screen. In another aspect, the present invention is a system and method for organizing a casino gambling experience. In yet another aspect, the present invention is a system utilizing machine learning techniques to ensure only the most relevant gambling content is presented to a user. Generally, the present invention is a system and method for utilizing artificial intelligence to manage displays and predictions in a gambling context.

The system preferably comprises a processor and a control board operably connected to the control board, wherein the control board is configured to manipulate a plurality of display windows of a display user interface. The system further includes a computing device having a user interface and operably connected to the control board, wherein a user accesses a user profile via the user interface of the control board. The computing device may transmit permission levels of user profiles to the control board, wherein the permission levels instruct the control board as to which content a user has permission to present via the display. The display is operably connected to the computing device and the control board and configured to present the display user interface having the plurality of display windows, wherein the control board manipulates the plurality of display windows of the display user interface presented on the display. The system may further comprise a microphone, a camera, a user proximity device with a sensor, or some combination of these operably connected to the control board, computing device, and processor.

Content related to gambling is preferably presented within the plurality of display windows of the display user interface. The system presents, via the display, the gambling content or game data within the plurality of display windows, and organizes, via the control board, the plurality of display windows based on adjustments to the gambling content or the game data. This gambling content may include a camera feed from a casino, television broadcasts of a sporting event, or online streaming of an event. Gambling content and game data presented within these display windows are managed by the control board. A non-transitory computer-readable medium operably connected to the processor preferably contains instructions stored thereon, which, when executed by the processor, cause the processor to perform various operations needed to organize and adjust gambling content or game data in the plurality of display windows.

These operations may use machine learning techniques to perform further operations like obtaining gambling content from one or more sources and obtaining game data from the gambling content. The camera and microphone may obtain image and audio data from the user and transmit the audio data to the control board. Machine learning is then used to determine the degree of interest possessed by the user in the gambling content or gaming data and organize the plurality of display windows based on all of the degrees of interest in the gambling content or gaming data of the user. Similarly, machine learning techniques may determine whether the audio data includes a command from a user to alter the displays or displayed content in some manner. Alternatively, machine learning techniques may be used to analyze user preferences saved in a user profile in conjunction with user proximity data to prioritize one or more types of gambling content on displays nearest to said user.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTION OF THE DRAWINGS

These and other features, aspects, and advantages of the present disclosure will become better understood with regard to the following description, appended claims, and accompanying drawings where:

FIG. 1 illustrates a system embodying features consistent with the principles of the present disclosure.

FIG. 2 illustrates a system embodying features consistent with the principles of the present disclosure.

FIG. 3 illustrates a system embodying features consistent with the principles of the present disclosure.

FIG. 4 illustrates a system embodying features consistent with the principles of the present disclosure.

FIG. 5 illustrates a system embodying features consistent with the principles of the present disclosure.

FIG. 6 illustrates a system embodying features consistent with the principles of the present disclosure.

FIG. 7 illustrates a system embodying features consistent with the principles of the present disclosure.

FIG. 8 illustrates a system embodying features consistent with the principles of the present disclosure.

FIG. 9 illustrates a system embodying features consistent with the principles of the present disclosure.

FIG. 10 illustrates the manner in which individual access to data may be granted or limited based on user roles and administrator roles.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For instance, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises”, and grammatical equivalents thereof are used herein to mean that other components, steps, etc. are optionally present. For instance, a system “comprising” components A, B, and C can contain only components A, B, and C, or can contain not only components A, B, and C, but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). As will be evident from the disclosure provided below, the present invention satisfies the need for a system and method for managing casino games and sports wagers on a split screen.

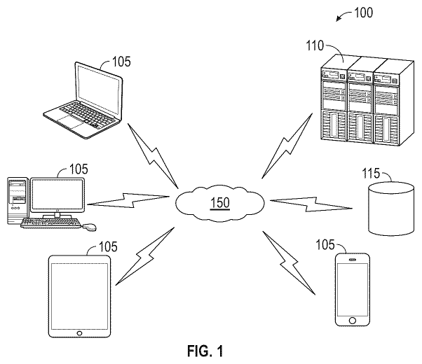

FIG. 1 depicts an exemplary environment 100 of the system 400 consisting of clients 105 connected to a server 110 and/or database 115 via a network 150. Clients 105 are devices of users 405 that may be used to access servers 110 and/or databases 115 through a network 150. A network 150 may comprise of one or more networks of any kind, including, but not limited to, a local area network (LAN), a wide area network (WAN), metropolitan area networks (MAN), a telephone network, such as the Public Switched Telephone Network (PSTN), an intranet, the Internet, a memory device, another type of network, or a combination of networks. In a preferred embodiment, computing entities 200 may act as clients 105 for a user 405. For instance, a client 105 may include a personal computer, a wireless telephone, a streaming device, a “smart” television, a personal digital assistant (PDA), a laptop, a smart phone, a tablet computer, or another type of computation or communication interface 280. Servers 110 may include devices that access, fetch, aggregate, process, search, provide, and/or maintain documents. Although FIG. 1 depicts a preferred embodiment of an environment 100 for the system 400, in other implementations, the environment 100 may contain fewer components, different components, differently arranged components, and/or additional components than those depicted in FIG. 1. Alternatively, or additionally, one or more components of the environment 100 may perform one or more other tasks described as being performed by one or more other components of the environment 100.

As depicted in FIG. 1, one embodiment of the system 400 may comprise a server 110. Although shown as a single server 110 in FIG. 1, a server 110 may, in some implementations, be implemented as multiple devices interlinked together via the network 150, wherein the devices may be distributed over a large geographic area and performing different functions or similar functions. For instance, two or more servers 110 may be implemented to work as a single server 110 performing the same tasks. Alternatively, one server 110 may perform the functions of multiple servers 110. For instance, a single server 110 may perform the tasks of a web server and an indexing server 110. Additionally, it is understood that multiple servers 110 may be used to operably connect the processor 220 to the database 115 and/or other content repositories. The processor 220 may be operably connected to the server 110 via wired or wireless connection. Types of servers 110 that may be used by the system 400 include, but are not limited to, search servers, document indexing servers, and web servers, or any combination thereof.

Search servers may include one or more computing entities 200 designed to implement a search engine, such as a documents/records search engine, general webpage search engine, etc. Search servers may, for instance, include one or more web servers designed to receive search queries and/or inputs from users 405, search one or more databases 115 in response to the search queries and/or inputs, and provide documents or information, relevant to the search queries and/or inputs, to users 405. In some implementations, search servers may include a web search server that may provide webpages to users 405, wherein a provided webpage may include a reference to a web server at which the desired information and/or links are located. The references to the web server at which the desired information is located may be included in a frame and/or text box, or as a link to the desired information/document. Document indexing servers may include one or more devices designed to index documents available through networks 150. Document indexing servers may access other servers 110, such as web servers that host content, to index the content. In some implementations, document indexing servers may index documents/records stored by other servers 110 connected to the network 150. Document indexing servers may, for instance, store and index content, information, and documents relating to user accounts and user-generated content. Web servers may include servers 110 that provide webpages to clients 105. For instance, the webpages may be HTML-based webpages. A web server may host one or more websites. As used herein, a website may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

As used herein, a database 115 refers to a set of related data and the way it is organized. Access to this data is usually provided by a database management system (DBMS) consisting of an integrated set of computer software that allows users 405 to interact with one or more databases 115 and provides access to all of the data contained in the database 115. The DBMS provides various functions that allow entry, storage and retrieval of large quantities of information and provides ways to manage how that information is organized. Because of the close relationship between the database 115 and the DBMS, as used herein, the term database 115 refers to both a database 115 and DBMS.

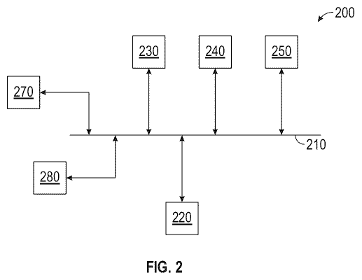

FIG. 2 is an exemplary diagram of a client 105, server 110, and/or or database 115 (hereinafter collectively referred to as “computing entity 200”), which may correspond to one or more of the clients 105, servers 110, and databases 115 according to an implementation consistent with the principles of the invention as described herein. The computing entity 200 may comprise a bus 210, a processor 220, memory 304, a storage device 250, a peripheral device 270, and a communication interface 280 (such as wired or wireless communication device). The bus 210 may be defined as one or more conductors that permit communication among the components of the computing entity 200. The processor 220 may be defined as logic circuitry that responds to and processes the basic instructions that drive the computing entity 200. Memory 304 may be defined as the integrated circuitry that stores information for immediate use in a computing entity 200. A peripheral device 270 may be defined as any hardware used by a user 405 and/or the computing entity 200 to facilitate communicate between the two. A storage device 250 may be defined as a device used to provide mass storage to a computing entity 200. A communication interface 280 may be defined as any transceiver-like device that enables the computing entity 200 to communicate with other devices and/or computing entities 200.

The bus 210 may comprise a high-speed interface 308 and/or a low-speed interface 312 that connects the various components together in a way such they may communicate with one another. A high-speed interface 308 manages bandwidth-intensive operations for computing device 300, while a low-speed interface 312 manages lower bandwidth-intensive operations. In some preferred embodiments, the high-speed interface 308 of a bus 210 may be coupled to the memory 304, display 316, and to high-speed expansion ports 310, which may accept various expansion cards such as a graphics processing unit (GPU). In other preferred embodiments, the low-speed interface 312 of a bus 210 may be coupled to a storage device 250 and low-speed expansion ports 314. The low-speed expansion ports 314 may include various communication ports, such as USB, Bluetooth, Ethernet, wireless Ethernet, etc. Additionally, the low-speed expansion ports 314 may be coupled to one or more peripheral devices 270, such as a keyboard, pointing device, scanner, and/or a networking device, wherein the low-speed expansion ports 314 facilitate the transfer of input data from the peripheral devices 270 to the processor 220 via the low-speed interface 312.

The processor 220 may comprise any type of conventional processor or microprocessor that interprets and executes computer readable instructions. The processor 220 is configured to perform the operations disclosed herein based on instructions stored within the system 400. The processor 220 may process instructions for execution within the computing entity 200, including instructions stored in memory 304 or on a storage device 250, to display graphical information for a graphical user interface (GUI) on an external peripheral device 270, such as a display 316. The processor 220 may provide for coordination of the other components of a computing entity 200, such as control of user interfaces 411, 511, 711, applications run by a computing entity 200, and wireless communication by a communication interface 280 of the computing entity 200. The processor 220 may be any processor or microprocessor suitable for executing instructions. In some embodiments, the processor 220 may have a memory device therein or coupled thereto suitable for storing the data, content, or other information or material disclosed herein. In some instances, the processor 220 may be a component of a larger computing entity 200. A computing entity 200 that may house the processor 220 therein may include, but are not limited to, laptops, desktops, workstations, personal digital assistants, servers 110, mainframes, cellular telephones, tablet computers, smart televisions, streaming devices, or any other similar device. Accordingly, the inventive subject matter disclosed herein, in full or in part, may be implemented or utilized in devices including, but are not limited to, laptops, desktops, workstations, personal digital assistants, servers 110, mainframes, cellular telephones, tablet computers, smart televisions, streaming devices, or any other similar device.

Memory 304 stores information within the computing device 300. In some preferred embodiments, memory 304 may include one or more volatile memory units. In another preferred embodiment, memory 304 may include one or more non-volatile memory units. Memory 304 may also include another form of computer-readable medium, such as a magnetic, solid state, or optical disk. For instance, a portion of a magnetic hard drive may be partitioned as a dynamic scratch space to allow for temporary storage of information that may be used by the processor 220 when faster types of memory, such as random-access memory (RAM), are in high demand. A computer-readable medium may refer to a non-transitory computer-readable memory device. A memory device may refer to storage space within a single storage device 250 or spread across multiple storage devices 250. The memory 304 may comprise main memory 230 and/or read only memory (ROM) 240. In a preferred embodiment, the main memory 230 may comprise RAM or another type of dynamic storage device 250 that stores information and instructions for execution by the processor 220. ROM 240 may comprise a conventional ROM device or another type of static storage device 250 that stores static information and instructions for use by processor 220. The storage device 250 may comprise a magnetic and/or optical recording medium and its corresponding drive.

As mentioned earlier, a peripheral device 270 is a device that facilitates communication between a user 405 and the processor 220. The peripheral device 270 may include, but is not limited to, an input device and/or an output device. As used herein, an input device may be defined as a device that allows a user 405 to input data and instructions that is then converted into a pattern of electrical signals in binary code that are comprehensible to a computing entity 200. An input device of the peripheral device 270 may include one or more conventional devices that permit a user 405 to input information into the computing entity 200, such as a controller, scanner, phone, camera, scanning device, keyboard, a mouse, a pen, voice recognition and/or biometric mechanisms, etc. As used herein, an output device may be defined as a device that translates the electronic signals received from a computing entity 200 into a form intelligible to the user 405. An output device of the peripheral device 270 may include one or more conventional devices that output information to a user 405, including a display 316, a printer, a speaker, an alarm, a projector, etc. Additionally, storage devices 250, such as CD-ROM drives, and other computing entities 200 may act as a peripheral device 270 that may act independently from the operably connected computing entity 200. For instance, a streaming device may transfer data to a smartphone, wherein the smartphone may use that data in a manner separate from the streaming device.

The storage device 250 is capable of providing the computing entity 200 mass storage. In some embodiments, the storage device 250 may comprise a computer-readable medium such as the memory 304, storage device 250, or memory 304 on the processor 220. A computer-readable medium may be defined as one or more physical or logical memory devices and/or carrier waves. Devices that may act as a computer readable medium include, but are not limited to, a hard disk device, optical disk device, tape device, flash memory or other similar solid-state memory device, or an array of devices, including devices in a storage area network or other configurations. Examples of computer-readable mediums include, but are not limited to, magnetic media such as hard disks, floppy disks, and magnetic tape; optical media such as CD ROM discs and DVDs; magneto-optical media such as optical discs; and hardware devices that are specially configured to store and perform programming instructions, such as ROM 240, RAM, flash memory, and the like.

In an embodiment, a computer program may be tangibly embodied in the storage device 250. The computer program may contain instructions that, when executed by the processor 220, performs one or more steps that comprise a method, such as those methods described herein. The instructions within a computer program may be carried to the processor 220 via the bus 210. Alternatively, the computer program may be carried to a computer-readable medium, wherein the information may then be accessed from the computer-readable medium by the processor 220 via the bus 210 as needed. In a preferred embodiment, the software instructions may be read into memory 304 from another computer-readable medium, such as data storage device 250, or from another device via the communication interface 280. Alternatively, hardwired circuitry may be used in place of or in combination with software instructions to implement processes consistent with the principles as described herein. Thus, implementations consistent with the invention as described herein are not limited to any specific combination of hardware circuitry and software.

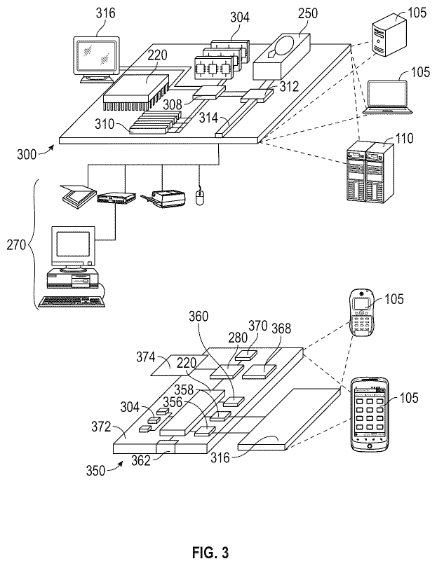

FIG. 3 depicts exemplary computing entities 200 in the form of a computing device 300 and mobile computing device 350, which may be used to carry out the various embodiments of the invention as described herein. A computing device 300 is intended to represent various forms of digital computers, such as laptops, desktops, workstations, servers 110, databases 115, mainframes, and other appropriate computers. A mobile computing device 350 is intended to represent various forms of mobile devices, such as scanners, scanning devices, personal digital assistants, cellular telephones, smart phones, tablet computers, and other similar devices. The various components depicted in FIG. 3, as well as their connections, relationships, and functions are meant to be examples only, and are not meant to limit the implementations of the invention as described herein. The computing device 300 may be implemented in a number of different forms, as shown in FIGS. 1 and 3. For instance, a computing device 300 may be implemented as a server 110 or in a group of servers 110. Computing devices 300 may also be implemented as part of a rack server system. In addition, a computing device 300 may be implemented as a personal computer, such as a desktop computer or laptop computer. Alternatively, components from a computing device 300 may be combined with other components in a mobile device, thus creating a mobile computing device 350. Each mobile computing device 350 may contain one or more computing devices 300 and mobile devices, and an entire system may be made up of multiple computing devices 300 and mobile devices communicating with each other as depicted by the mobile computing device 350 in FIG. 3. The computing entities 200 consistent with the principles of the invention as disclosed herein may perform certain receiving, communicating, generating, output providing, correlating, and storing operations as needed to perform the various methods as described in greater detail below.

In the embodiment depicted in FIG. 3, a computing device 300 may include a processor 220, memory 304 a storage device 250, high-speed expansion ports 310, low-speed expansion ports 314, and bus 210 operably connecting the processor 220, memory 304, storage device 250, high-speed expansion ports 310, and low-speed expansion ports 314. In one preferred embodiment, the bus 210 may comprise a high-speed interface 308 connecting the processor 220 to the memory 304 and high-speed expansion ports 310 as well as a low-speed interface 312 connecting to the low-speed expansion ports 314 and the storage device 250. Because each of the components are interconnected using the bus 210, they may be mounted on a common motherboard as depicted in FIG. 3 or in other manners as appropriate. The processor 220 may process instructions for execution within the computing device 300, including instructions stored in memory 304 or on the storage device 250. Processing these instructions may cause the computing device 300 to display graphical information for a GUI on an output device, such as a display 316 coupled to the high-speed interface 308. In other implementations, multiple processors and/or multiple buses may be used, as appropriate, along with multiple memory units and/or multiple types of memory. Additionally, multiple computing devices may be connected, wherein each device provides portions of the necessary operations.

A mobile computing device 350 may include a processor 220, memory 304 a peripheral device 270 (such as a display 316, a communication interface 280, and a transceiver 368, among other components). A mobile computing device 350 may also be provided with a storage device 250, such as a micro-drive or other previously mentioned storage device 250, to provide additional storage. Preferably, each of the components of the mobile computing device 350 are interconnected using a bus 210, which may allow several of the components of the mobile computing device 350 to be mounted on a common motherboard as depicted in FIG. 3 or in other manners as appropriate. In some implementations, a computer program may be tangibly embodied in an information carrier. The computer program may contain instructions that, when executed by the processor 220, perform one or more methods, such as those described herein. The information carrier is preferably a computer-readable medium, such as memory, expansion memory 374, or memory 304 on the processor 220 such as ROM 240, that may be received via the transceiver or external interface 362. The mobile computing device 350 may be implemented in a number of different forms, as shown in FIG. 3. For instance, a mobile computing device 350 may be implemented as a cellular telephone, part of a smart phone, personal digital assistant, or other similar mobile device.

The processor 220 may execute instructions within the mobile computing device 350, including instructions stored in the memory 304 and/or storage device 250. The processor 220 may be implemented as a chipset of chips that may include separate and multiple analog and/or digital processors. The processor 220 may provide for coordination of the other components of the mobile computing device 350, such as control of the user interfaces 411, 511, 711, applications run by the mobile computing device 350, and wireless communication by the mobile computing device 350. The processor 220 of the mobile computing device 350 may communicate with a user 405 through the control interface 358 coupled to a peripheral device 270 and the display interface 356 coupled to a display 316. The display 316 of the mobile computing device 350 may include, but is not limited to, Liquid Crystal Display (LCD), Light Emitting Diode (LED) display, Organic Light Emitting Diode (OLED) display, and Plasma Display Panel (PDP), holographic displays, augmented reality displays, virtual reality displays, or any combination thereof. The display interface 356 may include appropriate circuitry for causing the display 316 to present graphical and other information to a user 405. The control interface 358 may receive commands from a user 405 via a peripheral device 270 and convert the commands into a computer readable signal for the processor 220. In addition, an external interface 362 may be provided in communication with processor 220, which may enable near area communication of the mobile computing device 350 with other devices. The external interface 362 may provide for wired communications in some implementations or wireless communication in other implementations. In a preferred embodiment, multiple interfaces may be used in a single mobile computing device 350 as is depicted in FIG. 3.

Memory 304 stores information within the mobile computing device 350. Devices that may act as memory 304 for the mobile computing device 350 include, but are not limited to computer-readable media, volatile memory, and non-volatile memory. Expansion memory 374 may also be provided and connected to the mobile computing device 350 through an expansion interface 372, which may include a Single In-Line Memory Module (SIM) card interface or micro secure digital (Micro-SD) card interface. Expansion memory 374 may include, but is not limited to, various types of flash memory and non-volatile random-access memory (NVRAM). Such expansion memory 374 may provide extra storage space for the mobile computing device 350. In addition, expansion memory 374 may store computer programs or other information that may be used by the mobile computing device 350. For instance, expansion memory 374 may have instructions stored thereon that, when carried out by the processor 220, cause the mobile computing device 350 perform the methods described herein. Further, expansion memory 374 may have secure information stored thereon; therefore, expansion memory 374 may be provided as a security module for a mobile computing device 350, wherein the security module may be programmed with instructions that permit secure use of a mobile computing device 350. In addition, expansion memory 374 having secure applications and secure information stored thereon may allow a user 405 to place identifying information on the expansion memory 374 via the mobile computing device 350 in a non-hackable manner.

A mobile computing device 350 may communicate wirelessly through the communication interface 280, which may include digital signal processing circuitry where necessary. The communication interface 280 may provide for communications under various modes or protocols, including, but not limited to, Global System Mobile Communication (GSM), Short Message Services (SMS), Enterprise Messaging System (EMS), Multimedia Messaging Service (MMS), Code Division Multiple Access (CDMA), Time Division Multiple Access (TDMA), Personal Digital Cellular (PDC), Wideband Code Division Multiple Access (WCDMA), IMT Multi-Carrier (CDMAX 0), and General Packet Radio Service (GPRS), or any combination thereof. Such communication may occur, for example, through a transceiver 368. Short-range communication may occur, such as using a Bluetooth, WIFI, or other such transceiver 368. In addition, a Global Positioning System (GPS) receiver module 370 may provide additional navigation- and location-related wireless data to the mobile computing device 350, which may be used as appropriate by applications running on the mobile computing device 350. Alternatively, the mobile computing device 350 may communicate audibly using an audio codec 360, which may receive spoken information from a user 405 and covert the received spoken information into a digital form that may be processed by the processor 220. The audio codec 360 may likewise generate audible sound for a user 405, such as through a speaker, e.g., in a handset of mobile computing device 350. Such sound may include sound from voice telephone calls, recorded sound such as voice messages, music files, etc. Sound may also include sound generated by applications operating on the mobile computing device 350.

The system 400 may also comprise a power supply. The power supply may be any source of power that provides the system 400 with power. In an embodiment, the power supply may be a stationary power outlet. The system 400 may comprise of multiple power supplies that may provide power to the system 400 in different circumstances. For instance, the system 400 may be directly plugged into a stationary power outlet, which may provide power to the system 400 so long as it remains in one place. However, the system 400 may also be connected to a backup battery so that the system 400 may receive power even when the power supply is not connected to a stationary power outlet or if the stationary power outlet ceases to provide power to the computing entity 200.

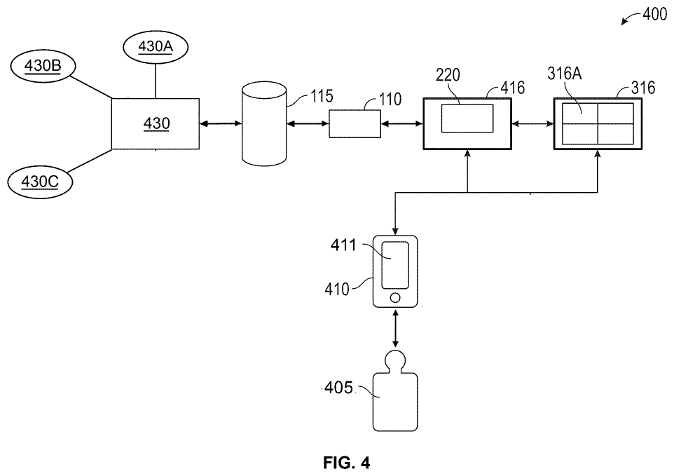

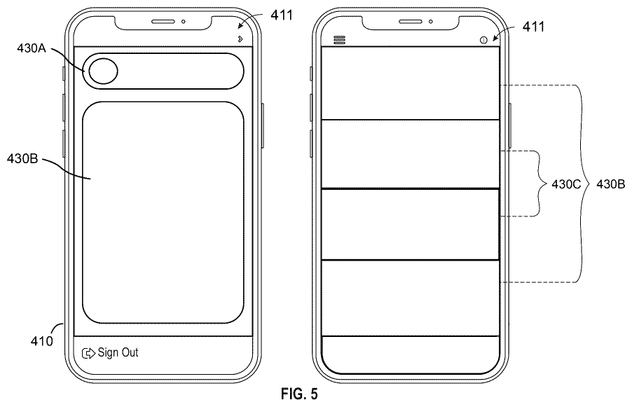

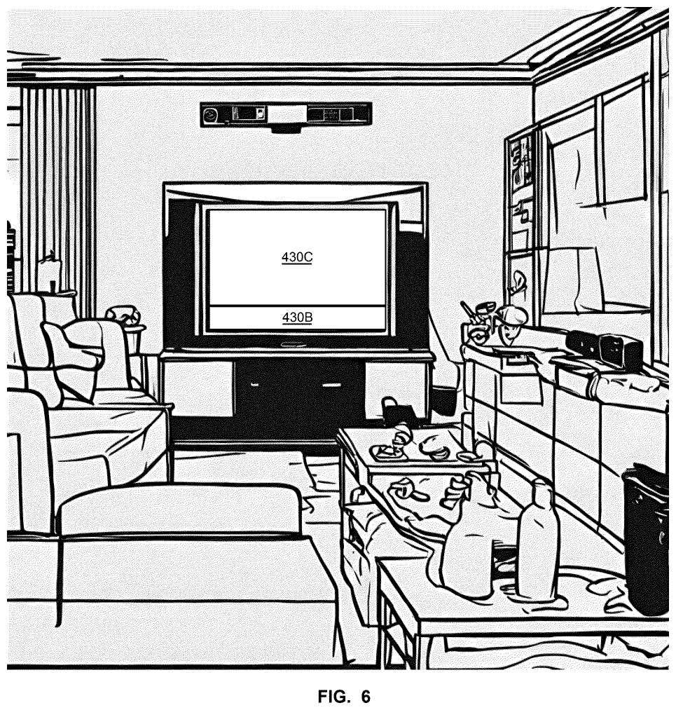

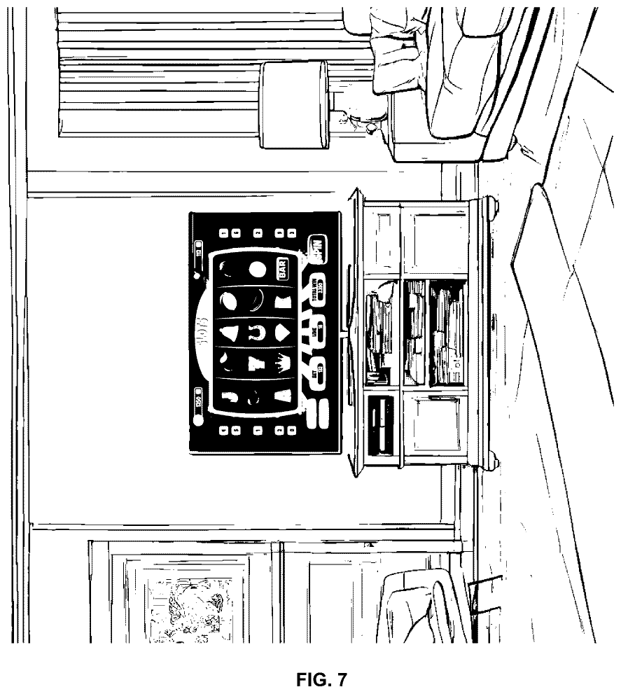

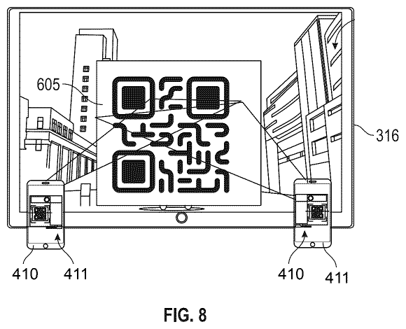

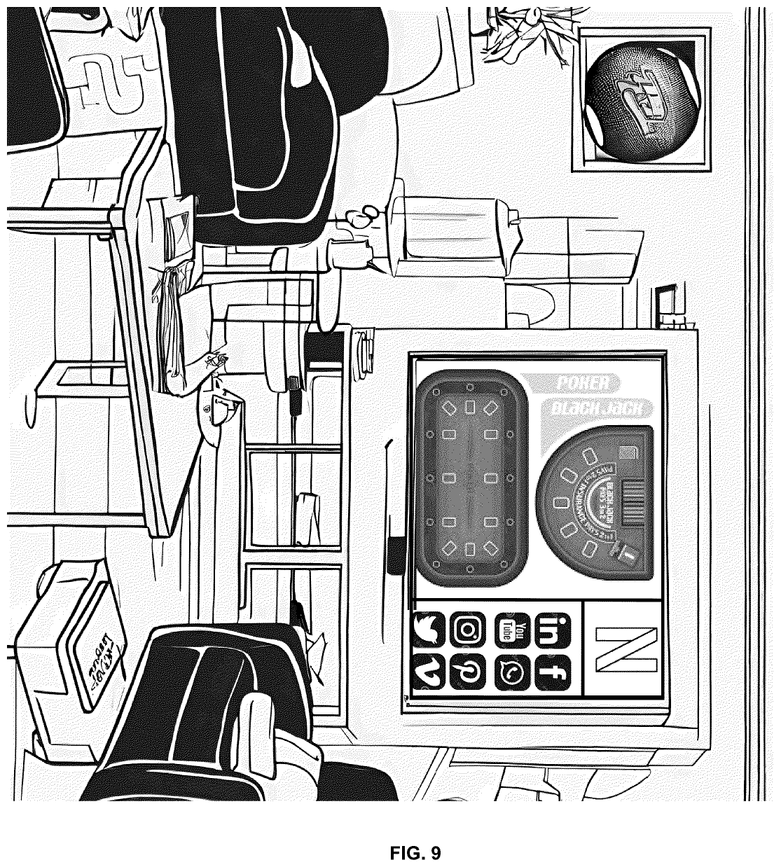

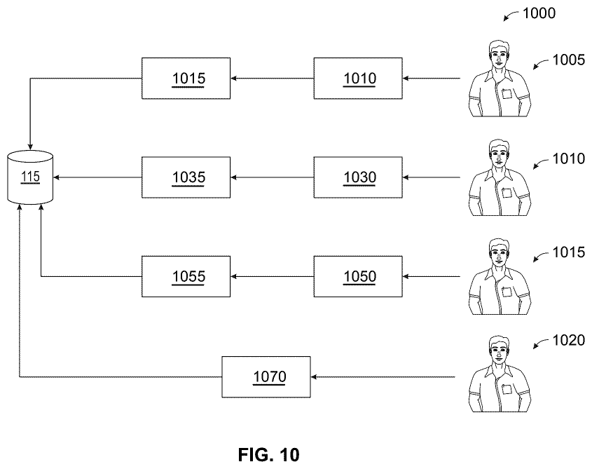

FIGS. 4-10 illustrate embodiments of a system 400 and methods for managing wagers and casino games on a display. FIG. 4 illustrates a preferred embodiment of the system 400 comprising a computing device 410 and display 316 in fluid communication with one another such that a user may choose sporting events, casino games, and/or other applications via a user interface of the computing device that will be presented in a display user interface of said display. FIG. 5 illustrates an example user interface 411 of the computing device 410 used by a user of the system to choose content to be displayed within a display user interface of the display. FIG. 6 illustrates an example display user interface 316A of a display 316 presenting potential wagers and sporting events specific to selected wagers, wherein a control board 409 operably connected to said display 316 is configured to control how the display windows of the display user interface are arranged. FIG. 7 illustrates an example display user interface 316A of a display 316 presenting casino games and application windows, wherein a control board 409 operably connected to said display 316 is configured to control how the casino games and application windows are arranged about the display via a plurality of display windows. FIG. 8 illustrates an example secondary security method that may be used to verify the identity of a user of the system. FIG. 9 illustrates the system 400 being used by a user 405 to place wagers on casino games while simultaneously enjoying content chosen via the user interface of the computing device. FIG. 10 illustrates permission levels 1000 that may be utilized by the present system 400 for controlling access to data of the system, such as user data 430A, game data 430B, and image data 430C. It is understood that the various method steps associated with any methods of the present disclosure may be carried out as operations by the system 400 shown in FIGS. 4-10.

The system 400 generally comprises a computing device 410 having a user interface 411, display 316 operably connected to said computing device, processor 220 operably connected to said computing device 410 and said display 316, and non-transitory computer-readable medium 416 coupled to said processor 220 and having instructions stored thereon. Some preferred embodiments may further comprise a camera operably connected to said computing device 410, wherein said camera is configured to capture image data that may be used to help identify a user of the system. In yet another preferred embodiment, a camera may be used to capture image data of casino games that may be presented to a user so that said user may make wagers. In other preferred embodiments, a database 115 may be operably connected to the processor 220 and the various data of the system 400 may be stored therein, including, but not limited to, user data 430A, game data 430B, and image data 430C.

In some preferred embodiments, a display 316 having a display user interface 316A and operably connected to the first computing device 410 may comprise a plurality of display windows configured to display game data 430B and image data 430C therein, wherein a control board 409 of the display 316 may be configured to receive said game data 430B and image data 430C. In yet another preferred embodiment, a wireless communication interface may allow the processors 220 of the system 400 to receive and transmit user data 430A, game data 430B, and image data 430C therebetween. In yet another preferred embodiment, a secondary security device may be used to allow for multifactor authentication of users of the system. The computing device 410, server 110, database 115, display 316, and secondary security device may be connected via a wired or wireless connection. In a preferred embodiment, the computing device 410 and/or display 316 are connected via a wireless connection, such as Bluetooth, whereas the secondary security device has a wired connection with the computing device 410 and/or display 316, allowing the processors 220 of the system 400 to receive and transmit user data 430A, game data 430B, and image data 430C therebetween.

Though referred to as a single computing device 410 of a particular user 405, one with skill in the art will recognize that multiple computing devices 410 of multiple users may be used without departing from the inventive subject matter described herein. Additionally, though referred to as a single display, one with skill in the art will recognize that multiple displays may be linked together in a way that creates a “single” display that may be used in a manner without departing from the inventive subject matter described herein. For instance, four OLED televisions may be linked together in way that creates a multi-display that the system may use as a “single” display. Additionally, one with skill in the art will recognize that a plurality of displays may be controlled by a single control board, and the single control board may manage the plurality of display windows about the display user interfaces of the plurality of displays. In yet another preferred embodiment, two or more control boards of two or more displays may be operably connected to one another and manage the plurality of display windows about the display user interfaces of the plurality of displays in collaboration with one another. Accordingly, one with skill in the art will recognize that displays may be used in combination with one or more control boards and one or more computing devices in a number of ways without departing from the inventive subject matter described herein.

In a preferred embodiment, a user 405 logs into a user profile of the system before accessing the various features of a display, allowing the system to verify the identity of the user. In another preferred embodiment, a system 400 can retrieve user data 430A associated with a user profile 430 that is stored on a different system 400 linked via a communication network like the Internet. By retrieving user profiles when prompted, the system 400 may import valuable data and avoid time-consuming setup of user preferences. However, in some embodiments, certain features of the display may be accessible without the user first logging into a user profile. A user interface 411 of a computing device 410 allows a user to input login credentials and/or commands. A processor 220 operably connected to said computing device and said display 316 sends the login credentials and/or commands to a control board of said display via a computer readable signal, wherein said login credentials and/or commands of said computer readable signal allow access to said display should they be associated with a user profile having sufficient permission levels. A user may then manipulate the user interface of the computing device in a way that allows said user to choose casino games and/or sports wagers to be presented on the display. In some preferred embodiments, a user 405 may be required to use a secondary security method to access a display in order to play casino games and/or make sports wagers on sporting events. For instance, a user 405 may be required to use a camera of their computing device 410 to scan a predefined pattern, such as a bar code or a QR code, of a display 316, as illustrated in FIG. 5, which may associate that user with a particular display. Secondary security methods may allow the user 405 to access content in the form of casino games, sports wagers, and/or sporting events.

In some preferred embodiments, the system 400 may further comprise a secondary security device. Devices that may act as the secondary security device may include, but are not limited to, biometric devices, key cards, wearables, or any combination thereof. In a preferred embodiment, devices that may act as the biometric devices include but are not limited to contact biometric devices, such as fingerprint scanners and hand geometry scanners, and/or non-contact biometric devices, such as face scanners, iris scanners, retina scanners, palm vein scanners, and voice identification devices. In some embodiments, the secondary security device may be operably connected to the computing device 410 and/or display 316 in a way such that it is in direct communication with the computing device 410 and/or display 316 and no other computing device 410 and/or display 316. For instance, the secondary security device in the form of a facial recognition camera may be securely and directly connected to a control board 409 of the display 316 such that a user 405 must biometrically scan their face prior to the system allowing access to casino games and sports wagers of the system. In some preferred embodiments, biometric data associated with a user is saved in a user profile as user data, which the system uses to verify a user's identity. For instance, the secondary security device may be securely and directly connected to the computing device in a way such that a user 405 must biometrically scan a thumbprint prior to the system allowing a user to access wager selection features of the user interface and/or display user interface.

In a preferred embodiment, key cards and wearables preferably comprise a secure transmitter configured to transmit a login credentials to the computing device and/or control board of the display. Wearables having a secure transmitter include clothing and accessories, such as a T-shirt, pants, jacket, belt, shoes, wristband, watch, glasses, pin, nametag, etc., that has said transmitter attached thereto and/or incorporated therein. The secure transmitter preferably contains login credentials in the form of a unique ID, which may be conveyed to the computing device and/or control board of the display 316 in the form of a computer readable signal. Unique IDs contained within the computer readable signal that has been broadcast by the transmitter may include, but are not limited to, unique identifier codes, social security numbers, PINs, etc. For instance, a computer readable signal broadcast by a secondary security device in the form of a hotel keycard may contain information that will alert the control board of the display 316 that a particular user 405 is within a certain range, which may cause the system 400 to allow a user to make wagers/bets via their computing device and/or display if additional steps are taken. Use of secondary security devices may be used solely or in addition to secondary security methods of the system, allowing the system to have flexible multifactor identification to suit the needs of its environment.

Types of devices that may act as the transmitter include, but are not limited, to near field communication (NFC), Bluetooth, infrared (IR), radio-frequency communication (RFC), radio-frequency identification (RFID), and ANT+, or any combination thereof. In an embodiment, transmitters may broadcast signals of more than one type. For instance, a transmitter comprising an IR transmitter and RFID transmitter may broadcast IR signals and RFID signals. Alternatively, a transmitter may broadcast signals of only one type of signal. For instance, key cards may be fitted with transmitters that broadcast NFC signals containing unique IDs associated with a particular user, wherein displays equipped with NFC receivers must receive said NFC signals containing unique IDs before access to one or more features of the display user interface may be granted.

Secondary security methods used by the system preferably require a scanning device and a predefined pattern of a display, such as a bar code or a QR code, wherein a user 405 must scan the predefined pattern via the scanning device before the system 400 will allow said user 405 to access the display 316. In a preferred embodiment, the scanning device is operably connected to the computing device, and wherein the computing device is operably connected to the system. Once scanned, the computing device may confirm the predefined pattern, and when confirmed, the computing device 410 may transmit a computer readable signal to the display 316, wherein said computer readable signal may contain the user's login credentials and/or biometric verification. For instance, a casino guest sitting in a sports pit may be required to scan a predefined pattern located in their seating area, wherein said predefined pattern is associated with a display within said sports pit, which may then cause the display 316 to activate and allow a user to place sports wagers on sporting events and/or bets on casino games. For instance, a guest on a cruise ship may scan a predefined pattern of a display 316 in their room using their computing device 410, which may activate the display and allow the user to play virtual slots in their room via said display and said computing device. Further, the system 400 may comprise a plurality of secondary security devices that may be used to identify users 405 of the system 400 and their permissions. For instance, the system 400 may use a combination of a biometric scanning device in addition to a secondary security method pertaining to the scanning of a QR code presented as a soft copy on a display in order to prevent unauthorized access to certain features of the display 316. Therefore, one with skill in the art will recognize that a plurality of methods and devices may be used in combination to prevent unwanted access to the various features of the system 400 without departing from the inventive subject matter described herein.

In embodiments where a user chooses casino games within the user interface and/or display user interface, the system may transmit image data of a casino game to the user and/or present a digital casino game to the user. The user may then use the user interface of the computing device or display user interface of the display to place bets, and the computing device and/or display user interface may present the image data of the casino game and/or digital casino game. In a preferred embodiment, casino games and/or casino game applications are presented to the user via the display 316 and bets are placed by a user via the computing device. Game data is transmitted between the display and computing device in a way that coordinates what onscreen casino game scenario is occurring and what action a user desires to take via the user interface and/or display user interface based on said onscreen casino game scenario. For instance, a casino game application presented via the display user interface for virtual poker may reveal the identity of a user's dealt cards and the community cards whereas the user interface of the computing device may allow a user to take actions, including, but not limited to, check, wager, and fold. For instance, a casino game application presented via the display user interface for slots may display a plurality of reels, bonus events, and selected paylines whereas the user interface of the computing device may allow a user to take actions, including, but not limited to, select paylines/credits and spin reels. For instance, a casino game application presented via the display user interface for blackjack may display dealer cards and player cards whereas the user interface of the computing device may allow a user to take actions, including, but not limited to, stand, hit, split, double down, and surrender.

In embodiments where a user chooses sports wagers for one or more sporting events, the system may obtain a plurality of sports odds and present them to a user, wherein the user may subsequently choose which one or more sports odds of the plurality of sports odds said user interested in placing one or more sports wagers on. Preferably, before the retrieval of image data associated with a sporting event is retrieved, a plurality of sports odds is presented to a user via the user interface of the computing device in embodiments where a user makes one or more sports wagers before being presented one or more sporting events. Once one or more sports wagers has been placed on one or more sports odds by a user via the system, the system may obtain image data of sporting events associated with the one or more sports wagers and present said image data of the sporting events in display windows of the display user interface.

In other preferred embodiments, a user may choose sporting events they would like to watch via the user interface of the computing device and/or display user interface of the display, causing the system to retrieve image data of the one or more sporting event. The system may then present sports a plurality of sports odds to the user related to the chosen sporting events via the user interface of the computing device and/or display user interface of the display. In one preferred embodiment, before a user is presented with a plurality of sports odds, retrieval of image data associated with one or more sporting events selected by a user via the user interface of the computing device is performed. In other preferred embodiments, a user may select one or more sporting events in the user interface or display user interface before choosing to place one or more sports wagers, but the system will require the user to choose one or more sports odds associated with said sporting event via the user interface before retrieval of image data associated with one or more sporting events may occur. In some preferred embodiments, the one or more sports wagers of the user interface are also presented within the plurality of display windows of the display.

In one preferred embodiment, the system 400 comprises a digital fantasy football league accessible via the user interface and/or display user interface. This digital fantasy football league preferably integrates seamlessly with the sports betting and casino game features of the system, providing users with a comprehensive and immersive sports entertainment experience. The fantasy football league allows users to create virtual teams composed of real NFL players, compete against other users, and earn points based on the statistical performance of their chosen players in actual NFL games. The fantasy football feature leverages the system's existing user data 430A, game data 430B, and image data 430C to enhance the user experience. For example, the system may use machine learning techniques to suggest player drafts or trades based on a user's historical preferences and betting patterns. The control board 409 of the display 316 may be configured to present fantasy football statistics and live NFL game feeds alongside other sports wagers and casino games within the plurality of display windows. In another preferred embodiment, machine learning techniques train the system 400 to only display games in which selected players are actively participating. Users 405 can access their fantasy football teams and make roster changes via the user interface 411 of the computing device 410 or the display user interface 316A. The system 400 may also offer exclusive sports wagers related to fantasy football performance, creating a unique synergy between fantasy sports and traditional sports betting. The exclusive nature of the fantasy football league ensures that only verified users 405 of the system can participate, maintaining the integrity of the game and complying with any relevant regulations. This feature may also serve as an additional incentive for new users to join the system. In another preferred embodiment, the system 400 comprises a digital fantasy league of another sport, such as soccer. In still another preferred embodiment, the system 400 comprises a digital tournament betting on game outcomes or other factors. For instance, the system 400 might organize and record the outcomes of a March Madness tournament.

In a preferred embodiment, the various data of the system 400 may be stored in user profiles 430. Types of data that may be stored within user profiles 430 of the system 400 include, but are not limited to, user data 430A, game data 430B, and image data 430C. One preferred embodiment of the system 400 may comprise a database 115 operably connected to the processor 220. The database 115 may be configured to store user data 430A, game data 430B, and image data 430C within said user profiles 430. As used herein, user data 430A may be defined as personal information of a user 405 that helps the system 400 identify the user 405, permissions of the user, and interests of a user. Types of data that may be used by the system 400 as user data 430A includes, but is not limited to, a user's name, username, social security number, phone number, gender, age, casino game preferences, sports preferences, sports team preference preferences, betting/wager preferences, food preferences, drink preferences, or any combination thereof. As used herein, game data 430B is data related to a particular casino game or sporting event as well as data pertaining to actions and/or bets placed by a user while playing a particular casino game or wagers made on a particular sporting event (whether the user is watching said sporting event or not). Types of data that may be used by the system 400 as game data 430B includes, but is not limited to, casino game data, action data, image data, sports odds data, bet/wager data, or any combination thereof.

In a preferred embodiment, the system 400 incorporates financial data in the user profiles 430 in order to facilitate the placing of bets among different users 405. This financial data may include information such as account balances, transaction history, credit limits, and preferred payment methods. By integrating financial data into user profiles 430, the system 400 can streamline the betting process, allowing users to place wagers quickly and efficiently without needing to input payment information for each transaction. The system may also use this financial data to implement responsible gambling features, such as setting personalized betting limits or triggering alerts when a user approaches their predetermined spending threshold. Additionally, the incorporation of financial data enables the system to facilitate peer-to-peer betting, where users can place wagers directly against each other, with the system acting as an intermediary to manage the financial transactions. This feature enhances the social aspect of sports betting and casino gaming, potentially increasing user engagement and retention. The system may also use the financial data to offer personalized promotions or bonuses based on a user's betting history and financial status, further enhancing the user experience while encouraging responsible gambling practices.

Image data 430C is used by the system in multiple ways. In one aspect, image data includes photographic or trace objects that represent the underlying pixel data of an area of an image element, which is created, collected, and stored using image constructor devices, such as a camera. The system may use image data obtained via a scanning device and/or a secondary security device to confirm the identity of a user. Image data of casino games and/or sporting events may be transmitted to the display and presented to the user. Image data may be transmitted to the display from the computing device to be presented within the plurality of display windows of the display. Accordingly, one with skill in the art will understand that image data 430C may be used by the system multiple ways to carry out various functions of the system without departing from the inventive subject matter described herein. User data 430A, game data 430B, and image data 430C in combination with permission levels 1000 is used by the system 400 to assist in presenting casino games and sporting odds to users within the display user interface 316A. A user 405 is preferably associated with a particular user profile 430 based on a username. However, it is understood that a user 405 may be associated with a user profile 430 using a variety of methods without departing from the inventive subject matter herein, including, but not limited to, biometric features, SSN, name, address, room number, or any combination thereof.

As previously mentioned, some preferred embodiments of the display 316 may further comprise a control board 409. The control board 409 comprises at least one circuit and microchip. In another preferred embodiment, the control board 409 may further comprise a wireless communication interface, which may allow the control board 409 to receive instructions from a computing device controlled by a user 405. In a preferred embodiment, the control board 409 may control the plurality of display windows of the display user interface 316A as well as the game data 430B and/or image data 430C displayed therein. The microchip of the control board 409 comprises a microprocessor and memory. In another preferred embodiment, the microchip may further comprise a wireless communication interface in the form of an antenna. The microprocessor may be defined as a multipurpose, clock driven, register based, digital-integrated circuit which accepts binary data as input, processes it according to instructions stored in its memory, and provides results as output. In a preferred embodiment, the microprocessor may receive image data 430C from a server 110 and/or database 115 via the wireless communication interface, wherein the image data 430C is preferably in the form of a video feed of a casino game and/or sporting event. For instance, a display may be configured to present image data of a basketball game in a display window of the display user interface, wherein the basketball game is related to game data in the form of a sports wager previously selected by a user. In some preferred embodiments, the plurality of display windows may contain game data 430B and image data 430C. For instance, a first display window may present a sporting event to a user; a second display window may present one or more sports wagers placed by a user on said sporting event; and a third display window may present a casino game feed, wherein the user may use the user interface of the computing device to place bets on the casino game.

In a preferred embodiment, the control board 409 of the display 316 receives data of the system 400 from the server 110 and/or database 115 and then present said data via a plurality of display windows of the display 316. The image data is streamed from the database 115 and/or server 110 to the control board 409, wherein the control board 409 inserts said image data into a display window. In another preferred embodiment, image data is transmitted to the display from the computing device, wherein the control board 409 inserts said image data into a display window. In some preferred embodiments, the control board may receive data from both the computing device and server/database simultaneously and subsequently control how said data is presented within the plurality of display windows of the display user interface.

The control board 409 may be configured to automatically select a layout of the display user interface 316A, wherein said layout may be determined based on a plurality of variables, including, but not limited to, number of users, type of content being viewed by the user(s) 405, user preferences, user location, or any combination thereof. In a preferred embodiment, the arrangement of display windows on one or more displays is determined by the user profiles 430 and proximities of one or more users. For example, when two users are detected near a display, the system analyzes their user profiles to identify common interests or active bets. If both users have placed wagers on an ongoing baseball game, the system recognizes this shared interest and automatically adjusts the display to prominently feature that game. This automatic adjustment ensures that relevant content is immediately accessible to the users without requiring manual input. The system's proximity detection capabilities may utilize various technologies, such as Bluetooth beacons, Wi-Fi triangulation, or NFC, to accurately determine user locations relative to displays. This location data is then correlated with user profile information stored in the database 115, allowing the system to make informed decisions about content presentation. In another preferred embodiment, the system may prioritize display space allocation based on factors such as bet amounts, user engagement levels, or the current state of the game. For instance, if one user has placed a significantly larger wager or has a history of higher engagement with baseball content, the system might allocate a larger portion of the display to the baseball game.

This dynamic arrangement capability extends beyond just two users and a single game. The system can handle multiple users with diverse interests, intelligently organizing the display to accommodate various sporting events, casino games, and other relevant content based on the collective preferences and active wagers of all nearby users. This flexibility ensures that the display remains relevant and engaging for groups of users with varying interests, potentially increasing user satisfaction and encouraging further interaction with the betting platform. Another. For instance, the control board 409 may select a layout for the display user interface that displays a plurality of sporting events in a single display based on game data 430B of the users 405. For instance, the control board 409 running a machine learning technique may select a layout for the display user interface that displays a video feed of a penalty shoot-out of a soccer match that a single user has placed a sports wager on. For instance, the control board 409 running a machine learning technique may be configured to only present image data of a basketball game when a particular basketball player is in the game. For instance, the control board 409 running a machine learning technique may organize display windows in multiple ways to allow for the presentation on multiple sporting events associated with multiple sports wagers placed by a user. Alternatively, a user may use the user interface of the computing device and/or display user interface of the display to determine a layout of the plurality of display windows.

Information presented via a display 316 may be referred to as a soft copy of the information because the information exists electronically and is presented for a temporary period of time. Information stored on the non-transitory computer-readable medium 416 may be referred to as the hard copy of the information. For instance, a display 316 may present a soft copy of visual information via a liquid crystal display 316 (LCD), wherein the hardcopy of the visual information is stored on a local hard drive. For instance, a display 316 may present a soft copy of audio information via a speaker, wherein the hard copy of the audio information is stored in RAM. For instance, a display 316 may present a soft copy of tactile information via a haptic suit, wherein the hard copy of the tactile information is stored within a database 115. Displays 316 may include, but are not limited to, cathode ray tube monitors, LCD monitors, light emitting diode (LED) monitors, gas plasma monitors, screen readers, speech synthesizers, haptic feedback equipment, virtual reality headsets, speakers, and scent generating devices, or any combination thereof.

The database 115 may be operably connected to the processor 220 via wired or wireless connection. In a preferred embodiment, the database 115 is configured to store user data 430A, game data 430B, and image data 430C within user profiles 430. Alternatively, the user data 430A, game data 430B, and image data 430C stored within user profiles 430 may be stored on the non-transitory computer-readable medium 416. The database 115 may be a relational database such that the user data 430A, game data 430B, and image data 430C associated with each user profile 430 and within the plurality of user profiles 430 may be stored, at least in part, in one or more tables. Alternatively, the database 115 may be an object database such that user data 430A, game data 430B, and image data 430C associated with each user profile 430 of the plurality of user profiles 430 may be stored, at least in part, as objects. In some instances, the database 115 may comprise a relational and/or object database and a server 110 dedicated solely to managing the user data 430A, game data 430B, and image data 430C in the manners disclosed herein.

As mentioned previously, some preferred embodiments of the system may further comprise a camera that may be used to capture image data. In one preferred embodiment, the camera may be used to capture a casino game feed, wherein said casino game feed is image data of a live casino game. In some preferred embodiments, the casino game feed may be transmitted to a display, allowing a user to make bets on said casino game via the system. For instance, a user presented a casino game feed via the display user interface may make bets on said casino game feed using their computing device. In a preferred embodiment, a casino game feed is presented to a user in real time. For instance, a casino game feed of a roulette table in a casino pit may be presented to a user in real time via a display located in a hotel room said user is resting. A user may use a computing device operably connected to the display to take actions in real time, including, but not limited to, place outside bet, place inside bet, place call bet, place final bet, and place imprisonment bet. In some preferred embodiments, a limited number of users may be allowed to view a casino game feed by the system. The system manages a maximum number of viewers of a casino game feed via the use of threshold limits.

The user interface 411 may be defined as a space where interactions between a user 405 and the system 400 may take place. In an embodiment, the interactions may take place in a way such that a user 405 may control the operations of the system 400. A user interface 411 may include, but is not limited to operating systems, command line user interfaces, conversational interfaces, web-based user interfaces, zooming user interfaces, touch screens, task-based user interfaces, touch user interfaces, text-based user interfaces, intelligent user interfaces, brain-computer interfaces (BCIs), and graphical user interfaces, or any combination thereof. The system 400 may present data of the user interface 411 to the user 405 via a display 316 operably connected to the processor 220. A display 316 may be defined as an output device that communicates data that may include, but is not limited to, visual, auditory, cutaneous, kinesthetic, olfactory, and gustatory, or any combination thereof.

In a preferred embodiment, commands input into the user interface of the computing device are sent to the display via the processor, wherein the commands instruct the control board as to what casino games, bets, sports wagers, and/or sporting events a user would like to choose. Preferably, a user chooses indicia within the user interface that are associated with commands that instruct the system to perform a particular action. In some embodiments, indicia may be associated with game data, and the computing device may transmit a computer readable signal containing game data 430B may instruct the system to perform an action. In one preferred embodiment, game data may be used to instruct the system to place a bet/wager in a manner instructed herein. In another preferred embodiment, game data may instruct the control board of the display to obtain image data 430C associated with the game data 430B, such as a casino game feed or sporting event, and/or casino game application associated with the game data 430B. In yet another preferred embodiment, the input commands are able to directly manage one or more windows of the display. For instance, a user disinterested in a baseball game in favor of a football game might instruct the display to mute a window containing the baseball game and unmute the window showing the football game. In some embodiments of the system, a gaming table may comprise an alerting means configured to alert a dealer that a user is using the system to make bets at said gaming table.

In one preferred embodiment, when a user accesses a casino game feed via the display and/or computing device, an alerting means operably connected to the system may indicate to a dealer that the user is playing the casino game virtually. Devices that may be used as the alerting means include, but are not limited to, lights, displays, or any combination thereof. For instance, a light operably connected to the system may alert the dealer of a blackjack table that a user of the system has accessed a casino game feed of the gaming table, alerting the dealer of the blackjack table to deal cards in way that allows the user to make wagers and take actions. In a preferred embodiment, image data may be used by the system to determine results of a casino game. For instance, a camera may collect image data that may be processed by the system via a machine learning technique to determine what cards a user has been dealt or what the total dice roll was.

In a preferred embodiment, the system 400 may use artificial intelligence (AI) techniques to perform functions of the system. In one preferred embodiment, AI techniques may be used to control the number of display windows presented within the display user interface. In another preferred embodiment, AI techniques may be used to recommend a plurality of sports odds to a user. In yet another preferred embodiment, AI techniques may be used to organize the plurality of display windows within the display user interface. The term “artificial intelligence” and grammatical equivalents thereof are used herein to mean an intelligence method used by the system 400 to correctly interpret and learn from data of the system 400 or a plurality of systems in order to achieve specific goals and tasks through flexible adaptation. Types of intelligence methods that may be used by the system 400 include, but are not limited to, machine learning, neural network, computer vision, or any combination thereof.

The system 400 preferably uses machine learning techniques to perform the methods disclosed herein, wherein the instructions carried out by the processor 220 for said machine learning techniques are stored on the non-transitory computer-readable medium 416, server 110, and/or database 115. Machine learning techniques that may be used by the system 400 include, but are not limited to, classification algorithms, neural network algorithm, regression algorithms, decision tree algorithms, clustering algorithms, genetic algorithms, supervised learning algorithms, semi-supervised learning algorithms, unsupervised learning algorithms, deep learning algorithms, or other types of algorithms. More specifically, machine learning algorithms can include implementations of one or more of the following algorithms: support vector machine, decision tree, nearest neighbor algorithm, random forest, ridge regression, Lasso algorithm, k-means clustering algorithm, boosting algorithm, spectral clustering algorithm, mean shift clustering algorithm, non-negative matrix factorization algorithm, elastic net algorithm, Bayesian classifier algorithm, RANSAC algorithm, orthogonal matching pursuit algorithm, bootstrap aggregating, temporal difference learning, backpropagation, online machine learning, Q-learning, stochastic gradient descent, least squares regression, logistic regression, ordinary least squares regression (OLSR), linear regression, stepwise regression, multivariate adaptive regression splines (MARS), locally estimated scatterplot smoothing (LOESS) ensemble methods, clustering algorithms, centroid based algorithms, principal component analysis (PCA), singular value decomposition, independent component analysis, k nearest neighbors (kNN), learning vector quantization (LVQ), self-organizing map (SOM), locally weighted learning (LWL), apriori algorithms, eclat algorithms, regularization algorithms, ridge regression, least absolute shrinkage and selection operator (LASSO), elastic net, classification and regression tree (CART), iterative dichotomiser 3 (ID3), C4.5 and C5.0, chi-squared automatic interaction detection (CHAID), decision stump, M5, conditional decision trees, least-angle regression (LARS), naive bayes, gaussian naïve bayes, multinomial naïve bayes, averaged one-dependence estimators (AODE), bayesian belief network (BBN), bayesian network (BN), k-medians, expectation maximisation (EM), hierarchical clustering, perceptron back-propagation, hopfield network, radial basis function network (RBFN), deep boltzmann machine (DBM), deep belief networks (DBN), convolutional neural network (CNN), stacked auto-encoders, principal component regression (PCR), partial least squares regression (PLSR), sammon mapping, multidimensional scaling (MDS), projection pursuit, linear discriminant analysis (LDA), mixture discriminant analysis (MDA), quadratic discriminant analysis (QDA), flexible discriminant analysis (FDA), bootstrapped aggregation (bagging), adaboost, stacked generalization (blending), gradient boosting machines (GBM), gradient boosted regression trees (GBRT), random forest, or even algorithms yet to be invented.

In a preferred embodiment, casino games, sporting events, and/or sports wagers are recommended to a user based on a user data contained within the user profile of the user. In a preferred embodiment, the system 400 may use more than one machine learning technique to determine which casino games, sporting events, and/or sports wagers may be most appealing to a user 405 based on their user data 430A within their user profile 430. For instance, a system 400 comprising a microphone may use a combination of natural language processing (NLP) and reinforcement learning to discern which sports and teams that a user 405 follows most passionately. If the system 400 determines that a user 405 is showing less interest in a particular sport or team, the system 400 may reduce the likelihood of recommending wagers for that particular sport and/or team. In another preferred embodiment, the system 400 may take into account the image data 430C of a sporting event and any associated game data 430B before recommending sports odds to a user. For instance, if a user 405 is watching a particular sporting event on a display, the system 400 may choose sports wagers related to that particular sporting event over other sports wagers related to different sporting events. In yet another preferred embodiment, the system 400 may utilize machine learning techniques to assess game data 430B and set appropriate stakes and odds for users 405 betting on the outcome of a sporting event.

The system's use of Natural Language Processing (NLP) to interpret verbal instructions represents a significant advancement in user interaction and accessibility. In some preferred embodiments, the system 400 uses NLP to receive and interpret direct verbal instructions relating to system functions. The system 400 may be designed to understand complex verbal instructions, including specific betting parameters. This level of sophistication allows users to place detailed wagers without the need for manual input through a graphical user interface. For example, a user might say, “Place a $50 bet on the Saints to win by more than 7 points in tonight's game,” and the system would be able to interpret and execute this command accurately. Sports betting and casino gaming often involve specialized terminology and jargon, which the system must be able to interpret correctly. This requires a robust NLP model that has been trained on domain-specific language and can accurately disambiguate terms that might have different meanings in other contexts.

The integration of NLP also opens up possibilities for further functionalities, such as conversational betting. In a preferred embodiment, users could potentially engage in a dialogue with the system, asking for odds, seeking clarification on betting rules, or requesting recommendations based on their betting history. This could create a more personalized and interactive betting experience. Additionally, the use of voice commands through NLP could enhance the system's accessibility features. Users with visual impairments or mobility issues that make it difficult to use traditional input methods could benefit greatly from the ability to place bets and interact with the system using voice commands. It is highly recommended that such NLP features be carefully designed to ensure security and prevent unauthorized access or manipulation. Voice recognition and authentication measures would likely need to be incorporated to verify the identity of users placing bets through voice commands.

In a preferred embodiment, the machine learning techniques comprise instructions configured to create a trained machine learning techniques from at least some training data and according to an implementation of the machine learning techniques, wherein the training data serves as a baseline dataset that may act as the foundational data of the machine learning techniques. The instructions of the machine learning techniques dictate how the machine learning techniques gain knowledge from the various data sources of the system and may comprise various types of programmable instructions that include, but are not limited to, local commands, remote commands, executable files, protocol commands, selected commands, or any combination thereof. The instructions of the machine learning techniques may vary widely, depending on a desired implementation. In a preferred embodiment, instructions may include streamed-lined instructions that instruct the machine learning techniques on how to train the system, possibly in the form of a script (e.g., Python, Ruby, JavaScript, etc.). In another preferred embodiment, the instructions may include data filters or data selection criteria that define requirements for desired results sets created from the various data of the system as well as which machine learning algorithm is to be used.

Training of the machine learning techniques may be supervised, semi-supervised, or unsupervised. In some preferred embodiments, the machine learning systems may use Natural Language Processing (NLP) to analyze data (e.g., audio data, text data, etc.). For instance, the system may use audio data of a user to determine which team a user believes might win a particular sporting event and propose prop bets of a type said user has historically favored based on information obtained via NLP. The historically favored prop bets may be derived by machine learning techniques by analyzing user data of said user related to prop bets. Training of the machine learning techniques may result in baseline machine learning techniques that may serve as AI techniques for managing display windows and recommending sports wagers in the manners described herein. Baseline machine learning techniques may further be configured to act as passive models or active models. A passive model may be described as a final, completed machine learning model that uses only the baseline data set to establish behavior of the baseline machine learning technique. An active model may be described as a plasticity machine learning model that is dynamic in that it may be updated using both the baseline dataset and data outside of the baseline data set.

In a preferred embodiment, the system may use a passive model to allow for a high degree of control as to how the system manages user interfaces and display windows in the manners described herein. For instance, a passive model may be configured via a private dataset to provide each user of the system with the same casino games, sporting events, and/or sports wagers recommendations. These recommendations may be made by the system regardless of user data that may indicate that particular users have historically preferred other casino games, sporting events, and/or sports wagers. However, a passive model may be especially useful for users having user profiles with little user data from which the machine learning techniques may learn from. In some preferred embodiments, the system may be configured to begin as passive models until a threshold amount of user data has been acquired. Once the threshold amount of user data has been acquired, the system may cause the machine learning techniques to switch to active models, allowing the system to make recommendations to a user that better parallel historical preferences of the user. For instance, a system may be configured to recommend sports odds for MLB games via a passive machine model until a user has placed a minimum of 50 sports wagers on MLB games. The system preferably presents sports odds determined by the passive machine model to a user via the computing device. Once the user has placed 50 separate sports wagers on MLB games, the machine learning techniques of the system may switch to an active machine model for that particular user and recommend sports odds determined by the active machine model.

In some embodiments, an active machine model may be updated in real-time, daily, weekly, bimonthly, monthly, quarterly, or annually using the various data (e.g., to update model instructions, shifts in time, new/corrected private data sets, user data, game data, etc.), of the system. In some preferred embodiments, the passive machine model may also be updated as new/updated private data sets become available. In a preferred embodiment, machine learning techniques comprise metadata that describe the state of the passive/active model with respect to its updates. The metadata may include attributes describing one or more of the following: a version number, date updated, amount of new data used for the update, shifts in model parameters, convergence requirements, or other information. Because each user of the system may potentially have a unique machine learning technique associated with their user profile due to the personal nature of user data associated with each user profile, such information allows for identifying distinct passive/active models within the system that may be separately managed.

To prevent un-authorized user from accessing other user's information, the system 400 may employ a security method. As illustrated in FIG. X, the security method of the system 400 may comprise a plurality of permission levels 1000 that may grant users 405 access to user content 1015, 1035, 1055 within the database while simultaneously denying users 405 without appropriate permission levels 1000 the ability to view user content 1015, 1035, 1055. To access the user content 1015, 1035, 1055 stored within the database 115, users 405 may be required to make a request via a user interface 411. Access to the data within the database 115 may be granted or denied by the processor 220 based on verification of a requesting user's 1005, 1025, 1045 permission level 1000. If the requesting user's 1005, 1025, 1045 permission level 1000 is sufficient, the processor 220 may provide the requesting user 1005, 1025, 1045 access to user content 1015, 1035, 1055 stored within the database. Conversely, if the requesting user's 1005, 1025, 1045 permission level 1000 is insufficient, the processor 220 may deny the requesting user 1005, 1025, 1045 access to user content 1015, 1035, 1055 stored within the database. In an embodiment, permission levels 1000 may be based on user roles 1010, 1030, 1050 and administrator roles 1070, as illustrated in FIG. 10. User roles 1010, 1030, 1050 allow requesting users 1005, 1025, 1045 to access user content 1015, 1035, 1055 that a user 405 has uploaded and/or otherwise obtained through use of the system 400. Administrator roles 1070 allow administrators 1065 to access system 400 wide data.

In an embodiment, user roles 1010, 1030, 1050 may be assigned to a user 405 in a way such that a requesting user 1005, 1025, 1045 may view user profiles 430 containing u user data 430A, game data 430B, and image data 430C via a user interface 411. To access the data within the database 115, a user 405 may make a user request via the user interface 411 to the processor 220. In an embodiment, the processor 220 may grant or deny the request based on the permission level 1000 associated with the requesting user 1005, 1025, 1045. Only users 405 having appropriate user roles 1010, 1030, 1050 or administrator roles 1070 may access the data within the user profiles 430. For instance, as illustrated in FIG. 10, requesting user 1 1005 has permission to view user 1 content 1015 and user 2 content 1035 whereas requesting user 2 1025 only has permission to view user 2 content 1035. Alternatively, user content 1015, 1035, 1055 may be restricted in a way such that a user may only view a limited amount of user content 1015, 1035, 1055. For instance, requesting user 3 1045 may be granted a permission level 1000 that only allows them to view user 3 content 1055 related to their specific interest but not user 3 content 1055 related to the identity of said user 405. In the example illustrated in FIG. 10, an administrator 1065 may bestow a new permission level 1000 on users 405 so that it may grant them greater permissions or lesser permissions. For instance, an administrator 1065 may bestow a greater permission level 1000 on other users 405 so that they may view user 3's content 1055 and/or any other user's content 1015, 1035, 1055. Therefore, the permission levels 1000 of the system 400 may be assigned to users 405 in various ways without departing from the inventive subject matter described herein.

The subject matter described herein may be embodied in systems, apparati, methods, and/or articles depending on the desired configuration. In particular, various implementations of the subject matter described herein may be realized in digital electronic circuitry, integrated circuitry, specially designed application specific integrated circuits (ASICs), computer hardware, firmware, software, and/or combinations thereof. These various implementations may include implementation in one or more computer programs that may be executable and/or interpretable on a programmable system including at least one programmable processor, which may be special or general purpose, coupled to receive data and instructions from, and to transmit data and instructions to, a storage system, and at least one peripheral device.

These computer programs, which may also be referred to as programs, software, applications, software applications, components, or code, may include machine instructions for a programmable processor, and may be implemented in a high-level procedural and/or object-oriented programming language, and/or in assembly machine language. As used herein, the term “non-transitory computer-readable medium” refers to any computer program, product, apparatus, and/or device, such as magnetic discs, optical disks, memory, and Programmable Logic Devices (PLDs), used to provide machine instructions and/or data to a programmable processor, including a non-transitory computer-readable medium that receives machine instructions as a computer-readable signal. The term “computer-readable signal” refers to any signal used to provide machine instructions and/or data to a programmable processor. To provide for interaction with a user, the subject matter described herein may be implemented on a computer having a display device, such as a cathode ray tube (CRD), liquid crystal display (LCD), light emitting display (LED) monitor for displaying information to the user and a keyboard and a pointing device, such as a mouse or a trackball, by which the user may provide input to the computer. Displays may include, but are not limited to, visual, auditory, cutaneous, kinesthetic, olfactory, and gustatory displays, or any combination thereof.

Other kinds of devices may be used to facilitate interaction with a user as well. For instance, feedback provided to the user may be any form of sensory feedback, such as visual feedback, auditory feedback, or tactile feedback; and input from the user may be received in any form including, but not limited to, acoustic, speech, or tactile input. The subject matter described herein may be implemented in a computing system that includes a back-end component, such as a data server, or that includes a middleware component, such as an application server, or that includes a front-end component, such as a client computer having a graphical user interface or a Web browser through which a user may interact with the system described herein, or any combination of such back-end, middleware, or front-end components. The components of the system may be interconnected by any form or medium of digital data communication, such as a communication network. Examples of communication networks may include, but are not limited to, a local area network (“LAN”), a wide area network (“WAN”), metropolitan area networks (“MAN”), and the internet.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For instance, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, devices, and arrangements of the parts and method stages which have been described and illustrated in order to explain the nature of this inventive subject matter can be made without departing from the principles and scope of the inventive subject matter.

What is claimed is:

1. A system for presenting content related to gambling on displays in an environment, comprising:
a control board configured to manipulate a plurality of display windows of a display user interface;
a computing device having a user interface and operably connected to said control board,
wherein a user accesses a user profile via said user interface of said control board,
wherein said computing device transmits a permission level of said user profile to said control board,
wherein said permission level instructs said control board as to which content said user has permission to present via said display;
a display operably connected to said computing device and said control board,
wherein said display is secured about an environment,
wherein said display is configured to present said display user interface having said plurality of display windows,
wherein said control board manipulates said plurality of display windows of said display user interface presented on said display,
wherein content related to gambling is presented within said plurality of display windows;
a processor operably connected to said control board and computing device; and,
a non-transitory computer-readable medium coupled to said processor,
wherein said non-transitory computer-readable medium contains instructions stored thereon, which, when executed by said processor, cause said processor to perform operations comprising:
determining an identity of said user accessing said user profile via said user interface of said control board,
retrieving a user profile having user data that pertains to said identity,
transmitting said permission level of said user profile to said control board,
determining to which said content said user has access based on said permission level,
obtaining, via a machine learning technique, gambling content from one or more sources,
obtaining, via a machine learning technique, game data from said gambling content,
presenting, via said display, said gambling content or game data within said plurality of display windows,
organizing, via said control board, said plurality of display windows based on adjustments to said gambling content or said game data.

2. The system of claim 1, wherein one or more of said sources comprises at least one of a gambling content camera, cable television network, satellite television networks, or online streaming service, wherein said source is operably connected to said control board, computing device, and processor.

3. The system of claim 2, further comprising a microphone operably connected to said control board, computing device, and processor.

4. The system of claim 3, wherein said microphone obtains audio data from said user and transmits said audio data to said control board.

5. The system of claim 4, further comprising additional instructions, which, when executed by said processor, cause said processor to perform additional operations comprising:
determining, using a machine learning technique, the degree of interest possessed by said user in said gambling content or gaming data,
organizing, using a machine learning technique, the plurality of display windows based on all of said degrees of interest in said gambling content or gaming data of said user.

6. The system of claim 4, further comprising additional instructions, which, when executed by said processor, cause said processor to perform additional operations comprising:
determining, using a machine learning technique, whether said audio data comprises a command to alter said gambling content or said gaming data displayed in said plurality of display windows,
determining whether said command is permissible based on said permission level associated with said user,
altering, using a machine learning technique, said gambling content or said game data displayed in said plurality of display windows if said command is permissible based on said permission level associated with said user, and
transmitting a message to be displayed on said plurality of display windows indicating a failure if said command is not permissible based on said permission level associated with said user.

7. The system of claim 2, further comprising a user response camera operably connected to said control board, computing device, and processor.

8. The system of claim 7, wherein said user response camera obtains image data of said user and transmits it to said control board.

9. The system of claim 8, further comprising additional instructions, which, when executed by said processor, cause said processor to perform additional operations comprising:
determining, using a machine learning technique, the degree of interest possessed by said user in said gambling content or gaming data,
organizing, using a machine learning technique, the plurality of display windows based on all of said degrees of interest in said gambling content or gaming data of said user.

10. The system of claim 2, further comprising one or more user proximity devices operably connected to said control board,
wherein said user proximity device comprises one or more sensors,
wherein said sensor of said user proximity device transmits user proximity data to said control board.

11. The system of claim 11, further comprising additional instructions, which, when executed by said processor, cause said processor to perform additional operations comprising:
determining, using a machine learning technique, the relative proximities of one or more said users to one or more said displays based on said user proximity data;
retrieving said user data associated with said user profiles of said user or users,
wherein said user data comprises the preferences of said user regarding said gambling content or said gaming data;
organizing, via a machine learning technique, said plurality of display windows based on said preferences of said user and said user proximity data;
adjusting, via a machine learning technique, said plurality of display windows based on changes to said preferences of a said user and said user proximity data.

12. A method for presenting content related to gambling on displays in an environment, comprising:
determining an identity of a user accessing a user profile via a user interface of a control board,
retrieving said user profile having user data that pertains to said identity,
transmitting a permission level of said user profile to said control board,
determining to which said content said user has access based on said permission level,
obtaining, via a machine learning technique, gambling content from one or more sources,
obtaining, via a machine learning technique, game data from said gambling content,
presenting, via a display, said gambling content or game data within a plurality of display windows,
organizing, via said control board, said plurality of display windows based on adjustments to said gambling content or said game data.

13. The method of claim 12, further comprising:
recording financial information pertaining to said user as financial data associated with said user profile,
wherein said financial data is such to enable execution of financial transactions based on said gambling content or gaming data;
obtaining authorization from said user to execute financial transactions utilizing said financial data;
executing said financial transactions on behalf of said user.

14. The method of claim 13, further comprising:
conditioning said financial transactions on behalf of said user on particular outcomes in said gambling content or gaming data.

15. The method of claim 14, wherein said financial transaction operates to transfer monetary funds from one of said users to another of said users.

16. The method of claim 14, wherein said financial transaction operates to transfer monetary funds from said user to an account, institution, or individual lacking a user profile.

17. The method of claim 12, wherein said financial data comprises at least one of credit card numbers, debit card numbers, card security codes, card expiration dates, checking account numbers, savings account numbers, and investment account numbers.

18. A non-transitory computer-readable medium containing instructions configured to present content related to gambling on displays in an environment, comprising:
a non-transitory computer-readable medium coupled to a processor,
wherein said non-transitory computer-readable medium contains instructions stored thereon, which, when executed by said processor, cause said processor to perform operations comprising:
determining an identity of a user accessing a user profile via a user interface of a control board,
retrieving said user profile having user data that pertains to said identity,
transmitting a permission level of said user profile to said control board,
determining to which said content said user has access based on said permission level,
obtaining, via a machine learning technique, gambling content from one or more sources,
obtaining, via a machine learning technique, game data from said gambling content,
presenting, via a display, said gambling content or game data within a plurality of display windows,
organizing, via said control board, said plurality of display windows based on adjustments to said gambling content or said game data.

19. The non-transitory computer-readable medium of claim 18, further comprising additional instructions, which, when executed by said processor, cause said processor to perform additional operations comprising:
analyzing, via a machine learning technique, said game data from said source,
wherein said game data comprises data from one or more current games and data from one or more past games,
wherein said game data comprises sufficient data from one or more past games to be analyzed via said machine learning techniques;
generating, via a machine learning technique, a prediction about the outcome of one or more current games;
displaying, via a machine learning technique, said prediction about said outcome in said display;
adjusting, via a machine learning technique, said prediction about said outcome in said display based on changes to said game data pertaining to said current game.

20. The non-transitory computer-readable medium of claim 19, further comprising additional instructions, which, when executed by said processor, cause said processor to perform additional operations comprising:
restricting, via a machine learning technique, said prediction about said outcome in said display to a display accessible only to a user of a particular permission level;
suggesting, via a machine learning technique, the stakes of a wager on said outcome based on said prediction,
wherein one or more users may wager monetary funds according to the terms of said stakes,
wherein said user of said particular permission level may modify said stakes of said wager before said stakes are displayed as gambling content on said plurality of display windows;
recording said wagers made by said users; and
dispersing, via a machine learning technique, monetary funds among said users according to said wagers.
